(19) United States
(12) Patent Application Publication
(10) Pub. No.: US 2015/0372540 A1
(43) Pub. Date: Dec. 24, 2015

(54) WIRELESS POWER TRANSMISSION SYSTEM

(71) Applicant: Murata Manufacturing Co., Ltd., Nagaokakyo-shi (JP)

(72) Inventors: HIRONOBU TAKAHASHI, Nagaokakyo-shi (JP); Tsutomu Ieki, Nagaokakyo-shi (JP)

(21) Appl. No.: 14/748,526

(22) Filed: Jun. 24, 2015

Related U.S. Application Data
(63) Continuation of application No. PCT/JP2013/083016, filed on Dec. 10, 2013.

(30) Foreign Application Priority Data
Feb. 15, 2013 (JP) 2013-027332

(51) Int. Cl. H02J 17/00; H02J 5/00

(52) U.S. Cl. CPC H02J 17/00; H02J 5/005

(57) ABSTRACT

A power transmission device includes a power-transmission-side active electrode and a power-transmission-side passive electrode. A power reception device includes a power-reception-side active electrode and a power-reception-side passive electrode. The power transmission device and the power reception device can be shifted along an X axis up to a maximum shift distance from a standard arrangement where electrode centers of the power-transmission-side active electrode and the power-reception-side active electrode oppose and are superposed with each other while maintaining the opposition surface area between the power-transmission-side active electrode and the power-reception-side active electrode.

### CROSS-REFERENCE TO RELATED APPLICATIONS

The present application is a continuation of PCT/JP2013/083016 filed Dec. 10, 2013, which claims priority to Japanese Patent Application No. 2013-027332, filed Feb. 15, 2013, the entire contents of each of which are incorporated herein by reference.

### FIELD OF THE INVENTION

The present invention relates to wireless power transmission systems in which power is transmitted from a power transmission device to a power reception device without a point of contact therebetween.

### BACKGROUND OF THE INVENTION

Wireless power transmission technologies have developed from the past into the field of supplying power to low-power household appliances such as electric toothbrushes, shavers and cordless telephones. In addition, in recent years, application of wireless power transmission technologies to portable appliances such as smartphones, laptops (notebook PCs), and tablet-type terminals has also been progressing.

Specific examples of wireless power transmission technology schemes include an electromagnetic induction scheme in which electromagnetic induction between coils is employed and an electric field coupling scheme in which electric field coupling between electrodes is employed. An electromagnetic-induction-scheme wireless power transmission system is a scheme in which electromagnetic induction is generated by bringing a power transmission coil and a power reception coil close to each other. In this scheme, there are problems in that there are large restrictions on the shapes and materials of the coils and in that power transmission characteristics are degraded by misalignment of the power transmission coil and the power reception coil, and there is a problem that the coils generate heat due to for example the presence of foreign metals between the power transmission coil and the power reception coil and the appliance overheats as a result.

On the other hand, an electric-field-coupling-scheme wireless power transmission system is a scheme in which two pairs of coupling electrodes made up of power transmission electrodes and power reception electrodes are provided and power is transmitted to the power reception side by applying an alternating current voltage from the power transmission side to an electrostatic capacitance formed when these two pairs of coupling electrodes are brought close to each other to generate electrostatic induction. This scheme is characterized in that there are few restrictions on the shapes and materials of the electrodes, the tolerance for misalignment of the power transmission electrodes and the power reception electrodes is high and it is unlikely that heat will be generated in the coupling unit (for example, refer to Patent Documents 1 and 2).

In addition, in electric-field-coupling-scheme wireless power transmission systems, when the voltages applied to the two pairs of coupling electrodes have different amplitudes, this is referred to as an unbalanced scheme or an unsymmetrical scheme, and the coupling electrodes to which a high voltage is applied are referred to as active electrodes and the coupling electrodes to which a low voltage is applied are referred to as passive electrodes.

Patent Document 1: Japanese Unexamined Patent Application Publication (Translation of PCT Application) No. 2009-531009.

Patent Document 2: Japanese Unexamined Patent Application Publication No. 2009-089520.

In electric-field-coupling-scheme wireless power transmission systems, the power transmission efficiency is greatly affected by the opposing surface areas between the power transmission electrodes and the power reception electrodes. Circuit constants inside the power transmission device and the power reception device are decided upon such that power is efficiently transmitted at the frequency of an alternating current voltage in accordance with the coupling capacitance generated between the power transmission electrodes and the power reception electrodes and therefore the power transmission efficiency drops if the value of the coupling capacitance substantially changes. Therefore, in order to realize a certain power transmission efficiency, it is necessary that a certain opposing surface area be maintained without change.

However, the two-dimensional relative positional relationship between the power reception device and the power transmission device is not necessarily fixed and variations may occur in the relative positional relationship between the two devices. For example, it is assumed that when a user places a portable appliance having a power reception device on a power transmission device, the appliance is placed in a state where the power reception device is shifted from a standard arrangement position of the power transmission device. Then, when a change occurs in the relative positional relationship and the opposing surface area between the power-transmission-side electrodes and the power-reception-side electrodes becomes smaller, the power transmission efficiency may no longer satisfy a required level. In addition, in an unbalanced electric-field-coupling-scheme wireless power transmission system, the power transmission efficiency may definitely no longer satisfy a required level as a result of the power-transmission-side active electrode and the power-reception-side passive electrode facing each other or the power-reception-side active electrode and the power-transmission-side passive electrode facing each other due to such a change occurring in the relative positional relationship between the power reception device and the power transmission device.

### SUMMARY OF THE INVENTION

Therefore, an object of the present invention is to provide an electric-field-coupling-scheme wireless power transmission system that is capable of suppressing a drop in power transmission efficiency even when the relative positional relationship between the power transmission device and the power reception device changes.

A wireless power transmission system according to the present invention includes a power transmission device and a power reception device. The power transmission device includes a first power transmission electrode, a second power transmission electrode and an alternating-current power generation circuit. The power reception device includes a first power reception electrode, a second power reception electrode and a load circuit. The first power transmission electrode is provided parallel to a transmission/reception opposition plane. The second power transmission electrode is provided parallel to the transmission/reception opposition plane, has an internal opening that surrounds the first power transmission electrode and is provided so as to be concentric with the first power transmission electrode. One end of the alternating-current power generation circuit is connected to the first power transmission electrode and the other end of the alternating-current power generation circuit is connected to the second power transmission electrode. The first power reception electrode is provided parallel to the transmission/reception opposition plane. The second power reception electrode is provided parallel to the transmission/reception opposition plane, has an internal opening that surrounds the first power reception electrode and is provided so as to be concentric with the first power reception electrode. One end of the load circuit is connected to the first power reception electrode and the other end of the load circuit is connected to the second power reception electrode. The first power transmission electrode and the first power reception electrode are provided such that one of the first power transmission electrode and the first power reception electrode surrounds the other when viewed in plan in a standard arrangement in which electrode centers of the first power transmission electrode and the first power reception electrode oppose and are superposed with each other. The second power transmission electrode and the second power reception electrode are provided such that one of the second power transmission electrode and the second power reception electrode surrounds the other in the standard arrangement when viewed in plan. The power transmission device and the power reception device can be shifted from the standard arrangement up to a maximum shift distance along a certain axis within the transmission/reception opposition plane while maintaining an opposition surface area between the first power transmission electrode and the first power reception electrode. In addition, in the standard arrangement, an edge of an electrode that is arranged on the outside among the first power transmission electrode and the first power reception electrode and a boundary line of the internal opening of an electrode that is arranged on the inside among the second power transmission electrode and the second power reception electrode are separated from each other along the certain axis by at least the maximum shift distance.

In this configuration, since the first power transmission electrode is surrounded by the second power transmission electrode and the first power reception electrode is surrounded by the second power reception electrode, noise radiated to the outside from the first power transmission electrode and the first power reception electrode is reduced. In addition, the power transmission device and the power reception device can be shifted from the standard arrangement along the certain axis up to the maximum shift distance while the opposing surface area between the first power transmission electrode and the first power reception electrode remains constant, and even if the devices are shifted from the standard arrangement along the certain axis, changing of the power transmission efficiency when the devices are shifted up to the limit of the maximum shift distance is suppressed. In addition, since there is a gap of at least the maximum shift distance along the certain axis from the edge of one of the first power transmission electrode and the first power reception electrode spaced further apart from the reference position along the certain axis to the second power transmission electrode and power reception electrode in the standard arrangement, the second power transmission electrode and the second power reception electrode do not oppose the first power reception electrode and the first power transmission electrode when the devices are shifted up to the limit of the maximum shift distance even if the devices are shifted along the certain axis from the standard arrangement and therefore lowering of the power transmission efficiency due to opposition of these electrodes can be prevented. Therefore, even if the user arranges the power reception device on the power transmission device at a shifted position of up to the maximum shift distance along the certain axis from the standard arrangement, lowering of the power transmission efficiency can be prevented.

In the above-described wireless power transmission system, the power transmission device and the power reception device can be shifted from the standard arrangement along a first certain axis where electrode centers of the first power transmission electrode and the first power reception electrode serve as a reference position while maintaining the opposition surface area between the first power transmission electrode and the first power reception electrode. When a11 denotes a dimension of one of the first power transmission electrode and the first power reception electrode along the first certain axis, a12 denotes a dimension of the other of the first power transmission electrode and the first power reception electrode along the first certain axis, and g11 denotes a dimensional difference between these two dimensions, a12−a11=g11>0. When a13 denotes a dimension of the internal opening of one of the second power transmission electrode and the second power reception electrode along the first certain axis and a14 denotes a dimension of the internal opening of the other of the second power transmission electrode and the second power reception electrode along the first certain axis, a13≦g11+a12 and a14≧a13 may hold true.

When it is considered that the power transmission device and the power reception device are able to be shifted in both directions along the first certain axis from the standard arrangement, the dimensional difference g11 between the first power transmission electrode and the first power reception electrode is at least twice the above-mentioned maximum shift distance. Therefore, even if the dimension a13 of the internal opening having the smaller dimension is suppressed such that a13≦g11+a12, a gap of at least the maximum shift distance can be secured up to the second power transmission electrode and the second power reception electrode on both sides of the first power transmission electrode and the first power reception electrode along the first certain axis. Then, even if the power transmission device and the power reception device are shifted from the standard arrangement by the maximum shift distance along the first certain axis, the second power transmission electrode and the second power reception electrode can be prevented from opposing the first power reception electrode and the first power transmission electrode. In other words, the dimension a13 of the internal opening can be suppressed and large electrode surface areas can be secured within limited electrode sizes while preventing the second power transmission electrode and the second power reception electrode from opposing the first power reception electrode and the first power transmission electrode.

In the above-described wireless power transmission system, a14≧g11+a13 may hold true.

Since the dimensional difference g11 is at least twice the above-mentioned maximum shift distance as described above, the dimension a14 of the internal opening is made to be the dimensional difference g11 larger than the dimension a13 of the internal opening, whereby even if a shift of the maximum shift distance occurs from the standard arrangement along the first certain axis, the opposition surface area between the second power transmission electrode and the second power reception electrode can be prevented from being reduced due to the misalignment of the second power transmission electrode and the second power reception electrode.

In the above-described wireless power transmission system, a11 denotes a dimension of the first power transmission electrode along the first certain axis, a13 denotes a dimension of the internal opening of the second power transmission electrode along the first certain axis, and a13=g11+a12 may hold true. Or, a11 denotes a dimension of the first power reception electrode along the first certain axis, a13 denotes a dimension of the internal opening of the second power reception electrode along the first certain axis, and a13=g11+a12 may hold true.

In these configurations, when a shift of the above-mentioned maximum shift distance occurs, the edges of the first power transmission electrode or the first power reception electrode and the second power reception electrode or the second power transmission electrode are superposed with each other. That is, a13=g11+a12 is an optimum point at which the dimension a13 of the internal opening is minimized while preventing the second power transmission electrode and the second power reception electrode from opposing the first power reception electrode and the first power transmission electrode. Therefore, the electrode surface areas can be maximized within limited electrode sizes while preventing the second power transmission electrode and the second power reception electrode from opposing the first power reception electrode and the first power transmission electrode.

In the above-described wireless power transmission system, the power transmission device and the power reception device can be shifted from the standard arrangement along a second axis that is orthogonal to the first certain axis at the reference position while maintaining the opposition surface area between the first power transmission electrode and the first power reception electrode. When a21 denotes a dimension of one of the first power transmission electrode and the first power reception electrode along the second axis, a22 denotes a dimension of the other of the first power transmission electrode and the first power reception electrode along the second axis, and g21 denotes a dimensional difference between these two dimensions, it is preferable that a22−a21=g21>0, and when a23 denotes a dimension of the internal opening of one of the second power transmission electrode and the second power reception electrode along the second axis and a24 denotes a dimension of the internal opening of the other of the second power transmission electrode and the second power reception electrode along the second axis, it is preferable that a23≦g21+a22 and a24≧a23. In particular, it is preferable that a11=a21, a12=a22, a13=a23 and a14=a24.

In these configurations, the devices can be shifted along the directions of two orthogonal axes in the transmission/reception opposition plane while the electrode opposition surface area is maintained, and in particular the arrangement states of the power transmission device and the power reception device can be interchanged in the directions of the two axes when the dimensional relationships are the same in the directions of the two axes.

In the above-described wireless power transmission system, it is preferable that the first power transmission electrode, the first power reception electrode, an opening shape of the second power transmission electrode and an opening shape of the second power reception electrode be circular.

In this configuration, misalignment of the power transmission device and the power reception device in the transmission/reception opposition plane can be permitted in all directions. Therefore, the power transmission efficiency can be made more stable.

In the above-described wireless power transmission system, it is preferable that the first power transmission electrode, the first power reception electrode, an opening shape of the second power transmission electrode and an opening shape of the second power reception electrode be rectangular.

With this configuration, the surface areas dedicated to electrodes can be maximized and the power transmission efficiency can be maximized in the case where the outer shapes of the casings of the power transmission device and the power reception device are rectangular in the transmission/reception opposition plane.

According to the present invention, a power transmission efficiency of a certain level or more can be stably realized even when a change occurs in a relative positional relationship between a power transmission device and a power reception device in a transmission/reception opposition plane between the power transmission device and the power reception device.

### BRIEF DESCRIPTION OF THE DRAWINGS

FIGS. 1(A)-(B) shows schematic diagrams of a wireless power transmission system according to a first embodiment of the present invention.

FIGS. 2(A)-(B) shows plan views illustrating a power transmission electrode pattern and a power reception electrode pattern of the wireless power transmission system according to the first embodiment of the present invention.

FIGS. 3(A)-(B) shows plan views illustrating certain arrangement states of the power transmission electrode pattern and the power reception electrode pattern of the wireless power transmission system according to the first embodiment of the present invention.

FIGS. 4(A)-(B) shows plan views illustrating certain arrangement states of a power transmission electrode pattern and a power reception electrode pattern of a wireless power transmission system according to a second embodiment of the present invention.

FIG. 5 is a plan view illustrating another arrangement state of a power transmission electrode pattern and a power reception electrode pattern of the wireless power transmission system according to the second embodiment of the present invention.

FIGS. 6(A)-(B) shows plan views illustrating the positional relationship between a power transmission electrode pattern and a power reception electrode pattern of a wireless power transmission system according to a third embodiment of the present invention.

FIGS. 7(A)-(D) shows plan views illustrating modifications of the power transmission electrode pattern and the power reception electrode pattern.

### DETAILED DESCRIPTION OF THE EXEMPLARY EMBODIMENTS

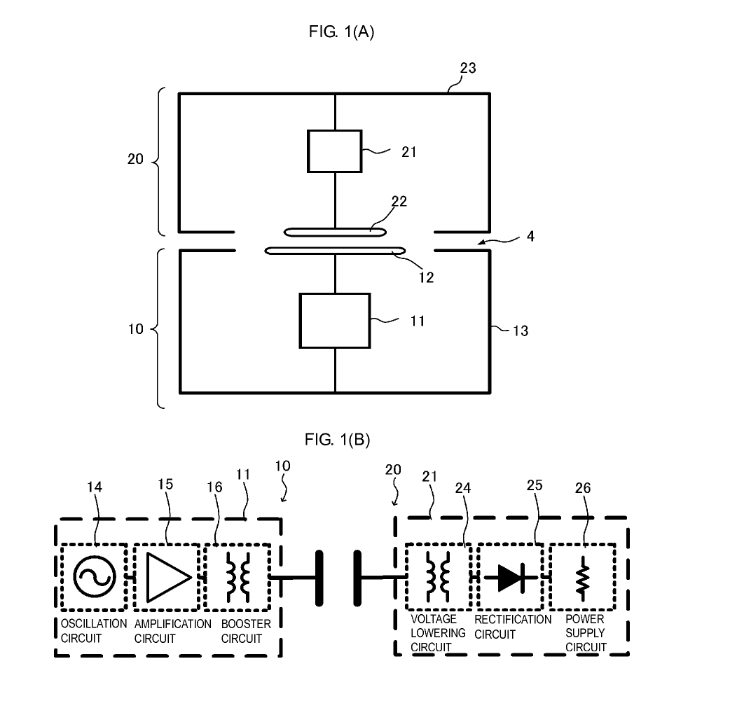

A wireless power transmission system according to a first embodiment of the present invention will be described. FIGS. 1(A)-(B) show schematic diagrams of the wireless power transmission system according to the first embodiment of the present invention. FIG. 1(A) is a configuration conceptual drawing. FIG. 1(B) is a function conceptual drawing.

The power transmission system illustrated in FIG. 1(A) is an unbalanced electric-field-coupling-scheme power transmission system and includes a power transmission device 10 and a power reception device 20. The power transmission device 10 is a device like a placement stand, such as a charging stand or a cradle equipped with a surface on which the power reception device 20 is to be placed. The power reception device 20 is a portable appliance such as a smartphone, a laptop (notebook PC) or a tablet-type terminal.

The power transmission device 10 includes an alternating-current power generation circuit 11, a power-transmission-side active electrode 12 and a power-transmission-side passive electrode 13. The alternating-current power generation circuit 11 is connected between the power-transmission-side active electrode 12 and the power-transmission-side passive electrode 13 and is arranged inside a casing, which is not illustrated, of the power transmission device 10. In addition, the power-transmission-side active electrode 12 and the power-transmission-side passive electrode 13, the specific planar shapes of which will be described later, are composed of plate-shaped electrodes and are arranged parallel to and close to a transmission/reception opposition plane of the casing inside the casing, which is not illustrated, of the power transmission device 10.

As illustrated in FIG. 1(B), the alternating-current power generation circuit 11 includes an oscillation circuit 14, an amplification circuit 15 and a voltage boosting circuit 16. The oscillation circuit 14 oscillates a high-frequency signal of 100 kHz to several tens of MHz. The amplification circuit 15 amplifies the amplitude of a high-frequency signal output from the oscillation circuit 14. The voltage boosting circuit 16 boosts a high-frequency signal output from the amplification circuit 15 and applies an alternating current voltage of several 100 V between the power-transmission-side active electrode 12 and the power-transmission-side passive electrode 13. Thus, setting is performed such that a potential at the power-transmission-side passive electrode 13 varies around a standard potential and so that a larger variation of potential occurs around a standard potential at the power-transmission-side active electrode 12 than at the passive electrode 13. The amplification circuit and booster circuit can be omitted if the oscillation circuit 14 has a sufficient output power and voltage.

The power reception device 20 includes a load circuit 21, a power-reception-side active electrode 22 and a power-reception-side passive electrode 23. The load circuit 21 is connected between the power-reception-side active electrode 22 and the power-reception-side passive electrode 23 and is arranged inside the casing, which is not illustrated, of the power reception device 20. In addition, the power-reception-side active electrode 22 and the power-reception-side passive electrode 23, the specific planar shapes of which will be described later, are composed of plate-shaped electrodes and are arranged parallel to and close to a transmission/reception opposition plane of the casing inside the casing, which is not illustrated, of the power reception device 20. The power-reception-side active electrode 22 opposes and is capacitively coupled with the power-transmission-side active electrode 12 of the power transmission device 10. In addition, the power-reception-side passive electrode 23 opposes and is capacitively coupled with the power-transmission-side passive electrode 13 of the power transmission device 10. Thus, an alternating-current voltage, which is high-frequency high-voltage, is applied between the power-reception-side passive electrode 23 and the power-reception-side active electrode 22 from the power transmission device 10.

As illustrated in FIG. 1(B), the load circuit 21 includes a voltage lowering circuit 24, a rectification circuit 25 and a power supply circuit 26. The voltage lowering circuit 24 lowers an alternating-current voltage, which is high-frequency high-voltage applied between the power-reception-side passive electrode 23 and the power-reception-side active electrode 22. The rectification circuit 25 rectifies an alternating current voltage output from the voltage lowering circuit 24. The power supply circuit 26 has for example the battery of a portable appliance as a load and feeds power from the rectified voltage output from the rectification circuit 25 to the battery or the like.

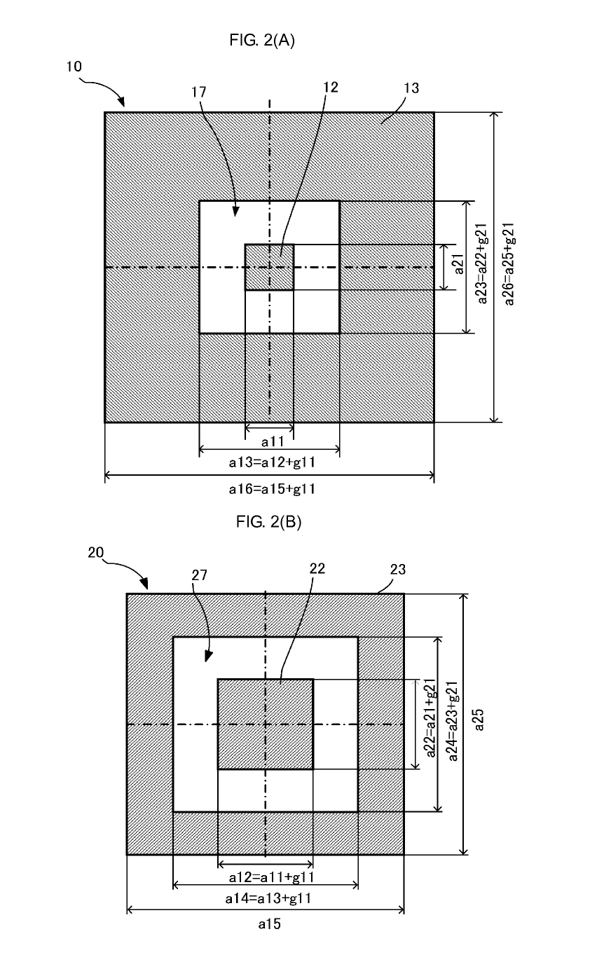

FIGS. 2(A)-(B) show plan views illustrating a power transmission electrode pattern and a power reception electrode pattern seen from a transmission/reception opposition plane in the wireless power transmission system according to the first embodiment. FIG. 2(A) illustrates the power transmission electrode pattern and FIG. 2(B) illustrates the power reception electrode pattern. Both of the electrode patterns are provided inside or on the surface of the casings of the power transmission device 10 and the power reception device 20 and illustration of constituent elements such as the casing of the portable appliance is omitted in FIG. 2(B), for example.

The power-transmission-side active electrode 12 has a square shape. The power-transmission-side passive electrode 13 has an annular shape, which has a square outer shape and has a square opening 17 provided inside thereof. The power-transmission-side active electrode 12 is arranged inside the opening 17 of the power-transmission-side passive electrode 13 and the power-transmission-side passive electrode 13 is arranged at a position so as to surround the power-transmission-side active electrode 12. The centers of the shapes of the power-transmission-side active electrode 12 and the power-transmission-side passive electrode 13 coincide with each other and the power-transmission-side active electrode 12 and the power-transmission-side passive electrode 13 are provided in a so-called concentric state. Therefore, the power-transmission-side active electrode 12 corresponds to a first power transmission electrode in the claims and the power-transmission-side passive electrode 13 corresponds to a second power transmission electrode in the claims.

The power-reception-side active electrode 22 has a square shape. The power-reception-side passive electrode 23 has an annular shape, which has a square outer shape and has a square opening 27 provided inside thereof. The power-reception-side active electrode 22 is arranged inside the opening 27 of the power-reception-side passive electrode 23 and the power-reception-side passive electrode 23 is arranged at a position so as to surround the power-reception-side active electrode 22. In addition, the centers of the shapes of the power-reception-side active electrode 22 and the power-reception-side passive electrode 23 coincide with each other and the power-reception-side active electrode 22 and the power-reception-side passive electrode 23 are provided in a so-called concentric state. Therefore, the power-reception-side active electrode 22 corresponds to a first power reception electrode in the claims and the power-reception-side passive electrode 23 corresponds to a second power reception electrode in the claims.

Here, edges of the power-transmission-side active electrode 12 in the horizontal direction in the figure have a dimension a11. In addition, edges of the power-reception-side active electrode 22 in the horizontal direction in the figure have a dimension alt. The dimension of the power-transmission-side active electrode 12 in the horizontal direction in the figure is smaller than that of the power-reception-side active electrode 22 and there is a dimensional difference g11 between the dimensions of the power-transmission-side active electrode 12 and the power-reception-side active electrode 22 in the horizontal direction in the figure. In other words, g11=a12−a11 and a12=a11+g11.

In addition, edges of the opening 17 of the power-transmission-side passive electrode 13 in the horizontal direction in the figure have a dimension a13. Edges of the opening 27 of the power-reception-side passive electrode 23 in the horizontal direction in the figure have a dimension a14. The opening dimension of the opening 17 of the power-transmission-side passive electrode 13 in the horizontal direction in the figure is larger than the dimension of the outer shape of the power-reception-side active electrode 22 and there is a dimensional difference g11 between the dimensions of the opening 17 and the power-reception-side active electrode 22 in the horizontal direction in the figure. In other words, a13=a12+g11. In addition, the dimension of the opening 27 of the power-reception-side passive electrode 23 in the horizontal direction in the figure is larger than that of the opening 17 of the power-transmission-side passive electrode 13 and there is a dimensional difference g11 between the dimensions of the opening 27 and the opening 17 in the horizontal direction in the figure. In other words, a14=a13+g11.

In addition, edges of the outer shape of the power-reception-side passive electrode 23 in the horizontal direction in the figure have a dimension a15. Furthermore, edges of outer shape of the power-transmission-side passive electrode 13 in the horizontal direction in the figure have a dimension a16. The dimension of the outer shape of the power-transmission-side passive electrode 13 in the horizontal direction in the figure is larger than that of the power-reception-side passive electrode 23 and there is a dimensional difference g11 between the dimensions of the power-transmission-side passive electrode 13 and the power-reception-side passive electrode 23 in the horizontal direction in the figure. In other words, a16=a15+g11. The power-transmission-side active electrode 12, the power-reception-side active electrode 22, the opening 17 of the power-transmission-side passive electrode 13, the opening 27 of the power-reception-side passive electrode 23, the outer shape of the power-reception-side passive electrode 23 and the outer shape of the power-transmission-side passive electrode 13 have dimensions in the vertical direction in the figure of a21, a22, a23, a24, a25 and a26, respectively, and a11=a21, a12=a22, a13=a23, a14=a24, a15=a25 and a16=a26. In addition, there is a dimensional difference g21 between the power-transmission-side active electrode 12 and the power-reception-side active electrode 22 in the vertical direction in the figure and g21=g11.

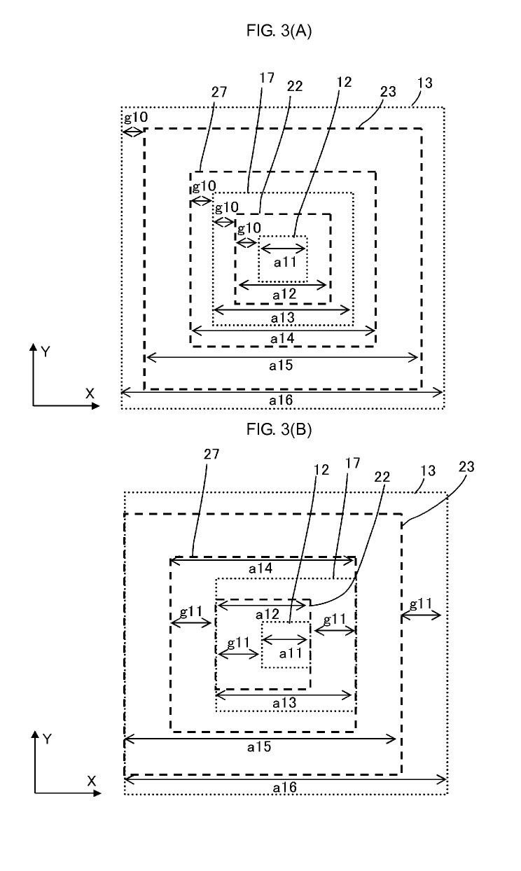

FIGS. 3(A)-(B) show plan views illustrating the positional relationship between the power transmission electrode pattern and the power reception electrode pattern in arrangement states where the power transmission device 10 and the power reception device 20 have been stacked one on top of the other in such a way that the edges of their electrode patterns are parallel to each other. FIG. 3(A) illustrates a standard arrangement in which centers of the electrodes of the power transmission electrode pattern and the power reception electrode pattern coincide with each other and FIG. 3(B) illustrates a maximally shifted arrangement in which the power transmission electrode pattern and the power reception electrode pattern have been shifted along an X axis to a limit of a maximum shift distance.

In the standard arrangement illustrated in FIG. 3(A), the power-transmission-side active electrode 12 is superposed so as to be contained within the power-reception-side active electrode 22 and the power-reception-side passive electrode 23 is superposed so as to be contained within the power-transmission-side passive electrode 13. In addition, in the standard arrangement illustrated in FIG. 3(A), there is a distance g10 from an electrode edge of the power-transmission-side active electrode 12 to an electrode edge of the power-reception-side active electrode 22 on both sides of the power-transmission-side active electrode 12 along the X axis. In this standard arrangement, the distance g10 is equal to ½ the dimensional difference g11 between the power-transmission-side active electrode 12 and the power-reception-side active electrode 22 and is equivalent to the maximum shift distance along the X axis.

In addition, in the maximally shifted arrangement illustrated in FIG. 3(B), an edge on the positive side in the X-axis direction among edges of the outer shape of the power-transmission-side active electrode 12 and an edge on the positive side in the X-axis direction among edges of the outer shape of the power-reception-side active electrode 22 are superposed with each other. Therefore, in this maximally shifted arrangement, the relative positional relationship between the power transmission device 10 and the power reception device 20 has been shifted along the X axis by the maximum shift distance g10 from the standard arrangement illustrated in FIG. 3(A).

In both the arrangement states illustrated in FIG. 3(A) and FIG. 3(B), the entirety of the power-transmission-side active electrode 12 is superposed with part of the power-reception-side active electrode 22 and an opposing surface area that is equal to the electrode area of the power-transmission-side active electrode 12 is secured between the power-transmission-side active electrode 12 and the power-reception-side active electrode 22. In other words, in both the arrangement states illustrated in FIG. 3(A) and FIG. 3(B), the power-transmission-side active electrode 12 is superposed so as to be contained within the power-reception-side active electrode 22 and the power-reception-side passive electrode 23 is superposed so as to be contained within the power-transmission-side passive electrode 13. If a change were to occur in the opposing surface area between the power-reception-side active electrode 22 and the power-transmission-side active electrode 12 due to the shifting of the relative positional relationship between the power transmission device 10 and the power reception device 20 along the X axis, the power transmission efficiency would be reduced due to the change in the capacitance. However, if the surface area of the power-reception-side active electrode 22 and the surface area of the power-transmission-side active electrode 12 are different from each other as in this embodiment, the power transmission device 10 and the power reception device 20 can be shifted relative to each other while the opposing surface area between the power-reception-side active electrode 22 and the power-transmission-side active electrode 12 remains constant. Specifically, as illustrated in this embodiment, by making the dimensional difference g11 between the dimension a12 of the power-reception-side active electrode 22 and the dimension a11 of the power-transmission-side active electrode 12 be a12−a11=g11>0, it is possible to allow the relative positional relationship between the power transmission device 10 and the power reception device 20 to be shifted by the maximum shift distance g10 along the X axis from the standard arrangement to the maximally shifted arrangement while a constant opposing surface area is maintained.

In addition, in both of the arrangement states illustrated in FIGS. 3(A) and 3(B), the power-reception-side passive electrode 23 and the power-transmission-side active electrode 12 do not oppose each other and the power-reception-side active electrode 22 and the power-transmission-side passive electrode 13 do not oppose each other. In particular, in the maximally shifted arrangement illustrated in FIG. 3(B), an edge on the negative side in the X-axis direction among the opening edges of the opening 17 and an edge on the negative side in the X-axis direction among the edges of the outer shape of the power-reception-side active electrode 22 are superposed with each other. In other words, the maximally shifted arrangement is also a limit at which the power-transmission-side passive electrode 13 and the power-reception-side active electrode 22 maintain a state of not opposing each other even if the power transmission device 10 and the power reception device 20 have been shifted from the standard arrangement along the X axis.

It is preferable that the openings 17 and 27 be large in order to prevent the power-reception-side passive electrode 23 and the power-transmission-side active electrode 12 from opposing each other and to prevent the power-reception-side active electrode 22 and the power-transmission-side passive electrode 13 from opposing each other, but conversely it is preferable that the openings 17 and 27 be small in order to secure large electrode areas within a limited electrode size. Consequently, here, by making the dimension a13 of the opening edges of the opening 17 be a13=a12+g11, the dimension a13 of the opening edges of the opening 17 is minimized while preventing with certainty the power-reception-side passive electrode 23 and the power-transmission-side active electrode 12 from opposing each other and preventing the power-reception-side active electrode 22 and the power-transmission-side passive electrode 13 from opposing each other when the power transmission device 10 and the power reception device 20 are shifted from the standard arrangement to the maximally shifted arrangement.

In addition, in both of the arrangement states illustrated in FIG. 3(A) and FIG. 3(B), the entirety of the power-reception-side passive electrode 23 is superposed with part of the power-transmission-side passive electrode 13, and an opposing surface area that is equal to the electrode area of the power-reception-side passive electrode 23 is secured between the power-reception-side passive electrode 23 and the power-transmission-side passive electrode 13. In particular, in the maximally shift arrangement illustrated in FIG. 3(B), an edge on the negative side in the X-axis direction among edges of the outer shape of the power-transmission-side passive electrode 13 and an edge on the negative side in the X-axis direction among edges of the outer shape of the power-reception-side passive electrode 23 are superposed with each other. In addition, an edge on the positive side in the X-axis direction among opening edges of the opening 17 and an edge on the positive side in the X-axis direction among opening edges of the opening 27 are superposed with each other. In other words, the maximally shifted arrangement is also a limit at which the opposing surface area between the power-transmission-side passive electrode 13 and the power-reception-side passive electrode 23 is maintained constant even if the power transmission device 10 and the power reception device 20 have been shifted from the standard arrangement along the X axis. Here, by making the dimension a14 of the opening edges of the opening 27 be a14=a13+g11 and the dimension a16 of the edges of the outer shape of the power-transmission-side passive electrode 13 be a16=a15+g11, the dimension a14 of the opening edges of the opening 27 and the dimension a16 of the power-transmission-side passive electrode 13 are minimized while maintaining the opposing surface area between the power-transmission-side passive electrode 13 and the power-reception-side passive electrode 23 constant with certainty when the power transmission device 10 and the power reception device 20 are shifted from the standard arrangement to the maximally shifted arrangement.

With this configuration, a constant power transmission efficiency can be maintained from the standard arrangement to the maximally shifted arrangement even if the relative positional relationship between the power transmission device 10 and the power reception device 20 is shifted along the X axis. The same is also true in the case in which the relative positional relationship is shifted along the Y axis. In other words, even though the dimensional relationship between the power transmission device 10 and the power reception device 20 is based on the X axis, the relationship would be the same even if the relationship were based upon the Y axis and therefore a constant power transmission efficiency can be maintained from the standard arrangement to the maximally shifted arrangement even if the relative positional relationship between the power transmission device 10 and the power reception device 20 is shifted along the Y axis, similarly to as in the case where it is shifted along the X axis.

In addition, the dimensional relationship between the power transmission device 10 and the power reception device 20 can be interchanged between the power transmission device 10 and the power reception device 20. Therefore, for example, the dimensions of the power-transmission-side active electrode 12 and the dimensions of the power-reception-side active electrode 22 may be interchanged, the dimensions of the power-transmission-side passive electrode 13 and the power-reception-side passive electrode 23 may be interchanged and the electrode patterns may be interchanged between the power transmission device 10 and the power reception device 20. In addition, in FIG. 2(A) and FIG. 2(B), the outer shape of the passive electrode in FIG. 2(B) is smaller. Accordingly, a system having a larger coupling capacitance can be formed by applying the configuration of FIG. 2(A) so that the device dimension that is the electrode opposing area of the power transmission device and the power reception device can be increased.

Next, a wireless power transmission system according to a second embodiment of the present invention will be described on the basis of an example configuration in which only the size relationships of the dimensions of the power-transmission-side active electrode and the power-reception-side active electrode are interchanged.

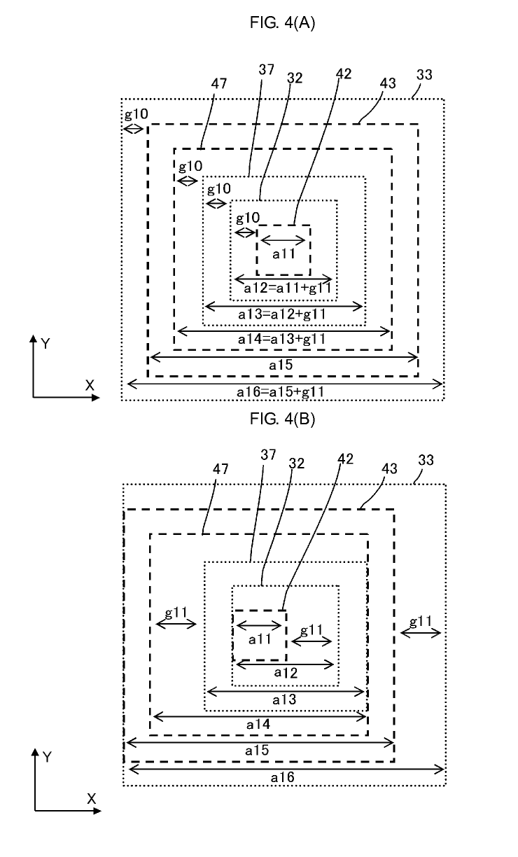

FIGS. 4(A)-(B) show plan views illustrating arrangement states in which a power transmission electrode pattern and a power reception electrode pattern of a power transmission device and a power reception device of the wireless power transmission system according to the second embodiment are stacked one on top of the other such that the edges thereof are parallel to each other. FIG. 4(A) illustrates a standard arrangement in which the centers of the power transmission electrode pattern and the power reception electrode pattern coincide with each other and FIG. 4(B) illustrates a maximally shifted arrangement in which the power transmission electrode pattern and the power reception electrode pattern have been shifted along an X axis to a limit of a maximum shift distance.

The power transmission device is equipped with a power-transmission-side active electrode 32 and a power-transmission-side passive electrode 33 as the power transmission electrode pattern. The power reception device is equipped with a power-reception-side active electrode 42 and a power-reception-side passive electrode 43 as the power reception electrode pattern.

The power-transmission-side active electrode 32 has a square shape. The power-transmission-side passive electrode 33 has an annular shape, which has a square outer shape and has a square opening 37 provided inside thereof. The power-transmission-side active electrode 32 is arranged inside the opening 37 of the power-transmission-side passive electrode 33 and the power-transmission-side passive electrode 33 is arranged at a position so as to surround the power-transmission-side active electrode 32. The centers of the shapes of the power-transmission-side active electrode 32 and the power-transmission-side passive electrode 33 coincide with each other and the power-transmission-side active electrode 32 and the power-transmission-side passive electrode 33 are provided in a so-called concentric state. Therefore, the power-transmission-side active electrode 32 corresponds to the first power transmission electrode in the claims and the power-transmission-side passive electrode 33 corresponds to the second power transmission electrode in the claims.

The power-reception-side active electrode 42 has a square shape. The power-reception-side passive electrode 43 has an annular shape, which has a square outer shape and has a square opening 47 provided inside thereof. The power-reception-side active electrode 42 is arranged inside the opening 47 of the power-reception-side passive electrode 43 and the power-reception-side passive electrode 43 is arranged at a position so as to surround the power-reception-side active electrode 42. In addition, the centers of the shapes of the power-reception-side active electrode 42 and the power-reception-side passive electrode 43 coincide with each other and the power-reception-side active electrode 42 and the power-reception-side passive electrode 43 are provided in a so-called concentric state. Therefore, the power-reception-side active electrode 42 corresponds to a first power reception electrode in the claims and the power-reception-side passive electrode 43 corresponds to a second power reception electrode in the claims.

Here, each edge of the power-transmission-side active electrode 32 has a dimension a12. In addition, each edge of the power-reception-side active electrode 42 has a dimension a11. The dimension of the power-transmission-side active electrode 32 is larger than that of the power-reception-side active electrode 42 and there is a dimensional difference g11 between the power-transmission-side active electrode 32 and the power-reception-side active electrode 42. In other words, g11=a12−a11 and a12=a11+g11.

In addition, each edge of the opening 37 of the power-transmission-side passive electrode 33 has a dimension a13. In addition, each edge of the opening 47 of the power-reception-side passive electrode 43 has a dimension a14. Further, there is a dimensional difference g11 between the opening 37 and the power-transmission-side active electrode 32. In other words, a13=a12+g11. In addition, the dimension of the opening 47 is larger than that of the opening 37 and there is a dimensional difference g11 between the opening 47 and the opening 37. In other words, a14=a13+g11.

In addition, each edge of the outer shape of the power-reception-side passive electrode 43 has a dimension a15. In addition, each edge of the outer shape of the power-transmission-side passive electrode 33 has a dimension a16. Furthermore, the dimension of the outer shape of the power-transmission-side passive electrode 33 is larger than that of the power-reception-side passive electrode 43 and there is a dimensional difference g11 between the outer shapes of the power-transmission-side passive electrode 33 and the power-reception-side passive electrode 43. In other words, a16=a15+g11.

The power-transmission-side active electrode 32, the power-reception-side active electrode 42, the opening 37 of the power-transmission-side passive electrode 33, the opening 47 of the power-reception-side passive electrode 43, the outer shape of the power-reception-side passive electrode 43 and the outer shape of the power-transmission-side passive electrode 33 have dimensions in the vertical direction in the figure of a22, a21, a23, a24, a25 and a26, respectively, and a11=a21, a12=a22, a13=a23, a14=a24, a15=a25 and a16=a26. In addition, there is a dimensional difference g21 between the power-transmission-side active electrode 32 and the power-reception-side active electrode 42 in the vertical direction in the figure and g21=g11.

In addition, in the standard arrangement illustrated in FIG. 4(A), there is a distance g10 from an electrode edge of the power-reception-side active electrode 42 to an electrode edge of the power-transmission-side active electrode 32 on both sides of the power-reception-side active electrode 42 along the X axis. In this standard arrangement, the distance g10 is equal to ½ the dimensional difference g11 between the power-transmission-side active electrode 32 and the power-reception-side active electrode 42 and is equivalent to the maximum shift distance along the X axis.

In addition, in the maximally shifted arrangement illustrated in FIG. 4(B), an edge on the negative side in the X-axis direction among edges of the outer shape of the power-transmission-side active electrode 32 and an edge on the negative side in the X-axis direction among edges of the outer shape of the power-reception-side active electrode 42 are superposed with each other. Therefore, in this maximally shifted arrangement, the relative positional relationship between the power transmission device and the power reception device has been shifted along the X axis by the maximum shift distance g10 from the standard arrangement illustrated in FIG. 4(A).

Also in the case where the power transmission electrode pattern and the power reception electrode pattern having the above-described shapes are made to face each other, by making the dimensional difference g11 between the dimension a11 of the power-reception-side active electrode 42 and the dimension alt of the power-transmission-side active electrode 32 be a12−a11=g11>0, it is possible to allow the relative positional relationship between the power transmission device and the power reception device to be shifted by the maximum shift distance g10 along the X axis from the standard arrangement to the maximally shifted arrangement while a constant opposing surface area is maintained. In addition, by making the dimension a13 of the opening edges of the opening 37 be a13=a12+g11, it is possible to prevent with certainty the power-reception-side passive electrode 43 and the power-transmission-side active electrode 32 from opposing each other and the power-reception-side active electrode 42 and the power-transmission-side passive electrode 33 from opposing each other when the power transmission device and the power reception device are shifted from the standard arrangement to the maximally shifted arrangement. Then, it is possible to suppress the dimension a13 of the opening 37 and secure large electrode surface areas within limited electrode sizes while preventing the power-transmission-side passive electrode 33 and the power-reception-side passive electrode 43 from opposing the power-reception-side active electrode 42 and the power-transmission-side active electrode 32. In addition, by making the dimension a14 of the opening edges of the opening 47 be a14=a13+g11 and the dimension a16 of the edges of the outer shape of the power-transmission-side passive electrode 33 be a16=a15+g11, the dimension a14 of the opening edges of the opening 47 and the dimension a16 of the power-transmission-side passive electrode 33 can be minimized while maintaining the opposing surface area between the power-transmission-side passive electrode 33 and the power-reception-side passive electrode 43 constant with certainty while allowing the power transmission device and the power reception device to be shifted from the standard arrangement to the maximally shifted arrangement.

With this configuration, a constant power transmission efficiency can be maintained from the standard arrangement to the maximally shifted arrangement even if the relative positional relationship between the power transmission device and the power reception device is shifted along the X axis. The same is also true in the case in which the relative positional relationship is shifted along the Y axis. In other words, even though the dimensional relationship between the power transmission device and the power reception device is based on the X axis, the relationship would be the same even if the relationship were based upon the Y axis and therefore a constant power transmission efficiency can be maintained from the standard arrangement to the maximally shifted arrangement even if the relative positional relationship between the power transmission device and the power reception device is shifted along the Y axis, similarly to as in the case where it is shifted along the X axis.

In addition, in this embodiment as well, the dimensional relationship between the power transmission electrode pattern and the power reception electrode pattern can be interchanged and for example the dimension of the power-transmission-side active electrode 32 and the dimension of the power-reception-side active electrode 42 may be interchanged, the dimension of the power-transmission-side passive electrode 33 and the dimension of the power-reception-side passive electrode 43 may be interchanged and the electrode patterns may be interchanged between the power transmission device and the power reception device.

Next, an arrangement state in which one of the power transmission device and the power reception device is rotated by 45° in the wireless power transmission system according to the second embodiment will be described. This is assumed to be a case in which the user arranges the power reception device in an incorrect arrangement state (angle) on the power transmission device.

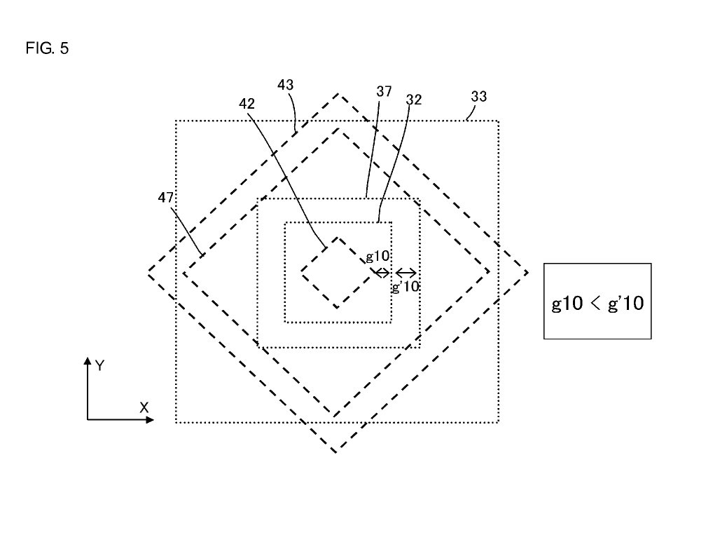

FIG. 5 illustrates a standard arrangement in which the power reception electrode pattern has been rotated by 45° while the power transmission electrode pattern according to the second embodiment has remained fixed.

In the standard arrangement illustrated in FIG. 5, the maximum shift distance g10 through which it is possible to shift along the X axis while maintaining the opposing surface area between the power-transmission-side active electrode 32 and the power-reception-side active electrode 42 constant is equal to ½ the dimensional difference between the dimension of each edge of the power-transmission-side active electrode 32 and the dimension of the diagonal of the power-reception-side active electrode 42. The dimension of the diagonal of the power-reception-side active electrode 42 is the square root of twice the dimension of each edge of the power-reception-side active electrode 42. Therefore, the maximum shift distance g10 in this arrangement state is smaller than the maximum shift distance in the arrangement state illustrated in FIG. 4.

Here, in the standard arrangement illustrated in FIG. 5, a distance g′10 from an edge of the power-transmission-side active electrode 32 on the positive side in the X-axis direction and from an edge of the power-transmission-side active electrode 32 on the negative side in the X-axis direction to an opening edge of the power-transmission-side passive electrode 33 or the power-reception-side passive electrode 43 along the X axis is considered. Along the whole length of both edges of the power-transmission-side active electrode 32, the distance g′10 is constant or the distance g′10 is greater than the maximum shift distance g10 in this arrangement state.

Therefore, in this arrangement state as well, it is possible to allow the power transmission device and the power reception device to be shifted from the standard arrangement along the X axis up to the maximum shift distance g10 while the opposing surface area between the power-transmission-side active electrode 32 and the power-reception-side active electrode 42 remains constant as in the arrangement state illustrated in FIG. 4. In addition, even if the power-transmission-side passive electrode 33 and the power-reception-side passive electrode 43 are shifted along the X axis from the standard arrangement, while they are shifted up to the limit of the maximum shift distance g10, the power-transmission-side passive electrode 33 and the power-reception-side passive electrode 43 do not oppose the power-reception-side active electrode 42 and the power-transmission-side active electrode 32 and lowering of the power transmission efficiency caused by opposition of these electrodes can be prevented. Then, it is possible to suppress the dimension a13 of the opening 37 and secure large electrode surface areas within limited electrode sizes while preventing the power-transmission-side passive electrode 33 and the power-reception-side passive electrode 43 from opposing the power-reception-side active electrode 42 and the power-transmission-side active electrode 32.

Thus, in the case where the user arranges the power reception device in an incorrect arrangement state (angle) on the power transmission device and there is a fixed shift in a certain direction, although the opposing surface area between the passive electrodes is reduced due to the rotation by 45°, lowering of the power transmission efficiency due to active electrodes and passive electrodes opposing each other can be suppressed.

In order to prevent lowering of the power transmission efficiency, it is preferable that the surface areas of both of the power-transmission-side active electrode 32 and the power-transmission-side passive electrode 33 or both of the power-reception-side active electrode 42 and the power-reception-side passive electrode 43 be made smaller than those of the opposing active electrode and passive electrode. By doing this, the active electrode-passive electrode distance can be set at the largest value and therefore opposition of an active electrode and a passive electrode can be suppressed even when there is a large shift.

Next, a wireless power transmission system according to a third embodiment of the present invention will be described on the basis of an example configuration in which the outer shape of each active electrode and the outer shape and the opening shape of each passive electrode is made to be a circular shape.

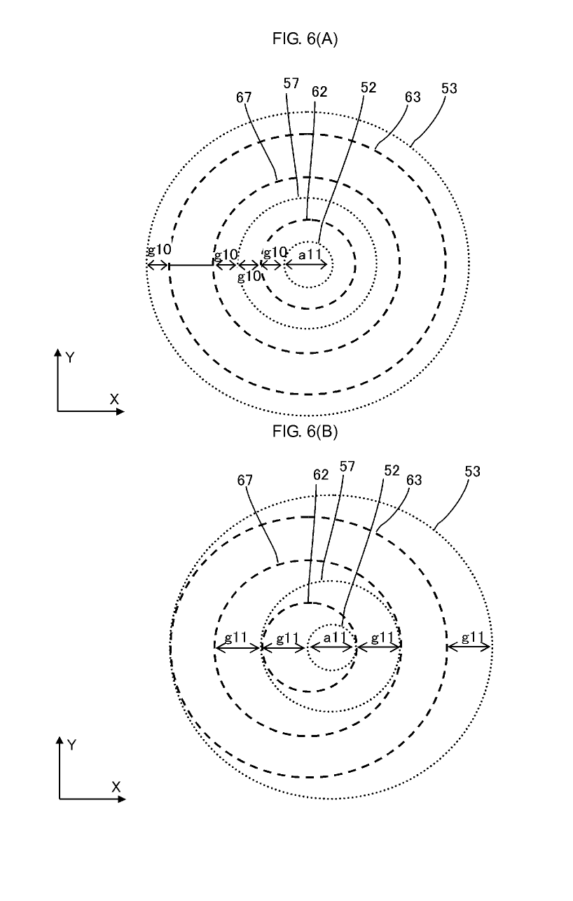

FIGS. 6(A)-(B) show plan views illustrating arrangement states in which a power transmission electrode pattern and a power reception electrode pattern of a power transmission device and a power reception device of the wireless power transmission system according to the third embodiment are stacked one on top of the other. FIG. 6(A) illustrates a standard arrangement in which the centers of the power transmission electrode pattern and the power reception electrode pattern coincide with each other and FIG. 6(B) illustrates a maximally shifted arrangement in which the power transmission electrode pattern and the power reception electrode pattern have been shifted along an X axis to a limit of a maximum shift distance.

The power transmission device is equipped with a power-transmission-side active electrode 52 and a power-transmission-side passive electrode 53 as the power transmission electrode pattern. The power reception device is equipped with a power-reception-side active electrode 62 and a power-reception-side passive electrode 63 as the power reception electrode pattern.

The power-transmission-side active electrode 52 has a circular shape. The power-transmission-side passive electrode 53 has an annular shape, which has a circular outer shape and has a circular opening 57 provided inside thereof. The power-transmission-side active electrode 52 is arranged inside the opening 57 of the power-transmission-side passive electrode 53 and the power-transmission-side passive electrode 53 is arranged at a position so as to surround the power-transmission-side active electrode 52. The centers of the shapes of the power-transmission-side active electrode 52 and the power-transmission-side passive electrode 53 coincide with each other and the power-transmission-side active electrode 52 and the power-transmission-side passive electrode 53 are provided in a so-called concentric state. Therefore, the power-transmission-side active electrode 52 corresponds to the first power transmission electrode in the claims and the power-transmission-side passive electrode 53 corresponds to the second power transmission electrode in the claims.

The power-reception-side active electrode 62 has a circular shape. The power-reception-side passive electrode 63 has an annular shape, which has a circular outer shape and has a circular opening 67 provided inside thereof. The power-reception-side active electrode 62 is arranged inside the opening 67 of the power-reception-side passive electrode 63 and the power-reception-side passive electrode 63 is arranged at a position so as to surround the power-reception-side active electrode 62. In addition, the centers of the shapes of the power-reception-side active electrode 62 and the power-reception-side passive electrode 63 coincide with each other and the power-reception-side active electrode 62 and the power-reception-side passive electrode 63 are provided in a so-called concentric state. Therefore, the power-reception-side active electrode 62 corresponds to the first power reception electrode in the claims and the power-reception-side passive electrode 63 corresponds to the second power reception electrode in the claims.

Here, the power-transmission-side active electrode 52 has a diameter a11. A diameter of the power-reception-side active electrode 62 is larger than that of the power-transmission-side active electrode 52 and there is a dimensional difference g11 between the power-reception-side active electrode 62 and the power-transmission-side active electrode 52. In addition, the diameter of the opening 57 of the power-transmission-side passive electrode 53 is made to be the dimensional difference g11 larger than the diameter of the power-reception-side active electrode 62. Furthermore, the diameter of the opening 67 of the power-reception-side passive electrode 63 is made to be the dimensional difference g11 larger than the diameter of the opening 57. In addition, the diameter of the outer shape of the power-reception-side passive electrode 63 is larger than the diameter of the opening 67. In addition, the diameter of the outer shape of the power-transmission-side passive electrode 53 is made to be the dimensional difference g11 larger than the diameter of the outer shape of the power-reception-side passive electrode 63.

In the standard arrangement illustrated in FIG. 6(A), there is a distance g10 from an electrode edge of the power-transmission-side active electrode 52 to an electrode edge of the power-reception-side active electrode 62 on both sides of the power-transmission-side active electrode 52 along the X axis. In this standard arrangement, the distance g10 is equal to ½ the dimensional difference g11 between the power-transmission-side active electrode 52 and the power-reception-side active electrode 62 and is equivalent to the maximum shift distance along the X axis.

In addition, in the maximally shifted arrangement illustrated in FIG. 6(B), a point on the positive side in the X-axis direction on the outer shape of the power-transmission-side active electrode 52 and a point on the positive side in the X-axis direction on the outer shape of the power-reception-side active electrode 62 are superposed with each other. Therefore, in this maximally shifted arrangement, the relative positional relationship between the power transmission device and the power reception device has been shifted along the X axis by the maximum shift distance g10 from the standard arrangement illustrated in FIG. 6(A).

Also in the case where the power transmission electrode pattern and the power reception electrode pattern having the above-described shapes are made to face each other, by making there be the dimensional difference g11 between the power-transmission-side active electrode 52 and the power-reception-side active electrode 62, it is possible to allow the relative positional relationship between the power transmission device and the power reception device to be shifted by the maximum shift distance g10 along the X axis from the standard arrangement to the maximally shifted arrangement while a constant opposing surface area is maintained. In addition, by making the diameter of the opening 57 be the dimensional difference g11 larger than the diameter of the power-reception-side active electrode 62, it is possible to prevent with certainty the power-reception-side passive electrode 63 and the power-transmission-side active electrode 52 from opposing each other and the power-reception-side active electrode 62 and the power-transmission-side passive electrode 53 from opposing each other when the power transmission device and the power reception device are shifted from the standard arrangement to the maximally shifted arrangement. Then, it is possible to minimize the diameter of the opening 57 and secure large electrode surface areas within limited electrode sizes while preventing the power-transmission-side passive electrode 53 and the power-reception-side passive electrode 63 from opposing the power-reception-side active electrode 62 and the power-transmission-side active electrode 52. In addition, by making the diameter of the opening 67 be the dimensional difference g11 larger than the diameter of the opening 57 and making the diameter of the power-transmission-side passive electrode 53 be the dimensional difference g11 larger than the diameter of the power-reception-side passive electrode 63, the diameter of the opening 57 and the diameter of the power-transmission-side passive electrode 53 can be minimized while maintaining the opposing surface area between the power-transmission-side passive electrode 53 and the power-reception-side passive electrode 63 constant with certainty when the power transmission device and the power reception device are shifted from the standard arrangement to the maximally shifted arrangement.

With this configuration, a constant power transmission efficiency can be maintained from the standard arrangement to the maximally shifted arrangement even if the relative positional relationship between the power transmission device and the power reception device is shifted along the X axis. The same is also true in the case where the relative positional relationship is shifted along any axis on the transmission/reception opposition plane, not just the X axis. In other words, the same is true regardless of what axis the dimensional relationship between the power transmission device and the power reception device is based upon and therefore a constant power transmission efficiency can be maintained from the standard arrangement to the maximally shifted arrangement even if the relative positional relationship between the power transmission device and the power reception device is shifted along any axis. In addition, even if the devices are arranged in a state where they are rotated at 45° for example as illustrated in FIG. 5, a relative positional relationship that is the same as the standard arrangement is maintained. Therefore, it is preferable that circular active electrodes and passive electrodes be adopted in a wireless power transmission system in which such a rotation may occur in the arrangement relationship.

In addition, in this embodiment as well, the dimensional relationship between the power transmission electrode pattern and the power reception electrode pattern can be interchanged, the dimensional relationship between the power-transmission-side active electrode and the power-reception-side active electrode can be interchanged and the dimensional relationship between the power-transmission-side passive electrode and the power-reception-side passive electrode can be interchanged.

Next, modifications of the shapes of the power transmission electrode pattern and the power reception electrode pattern will be described.

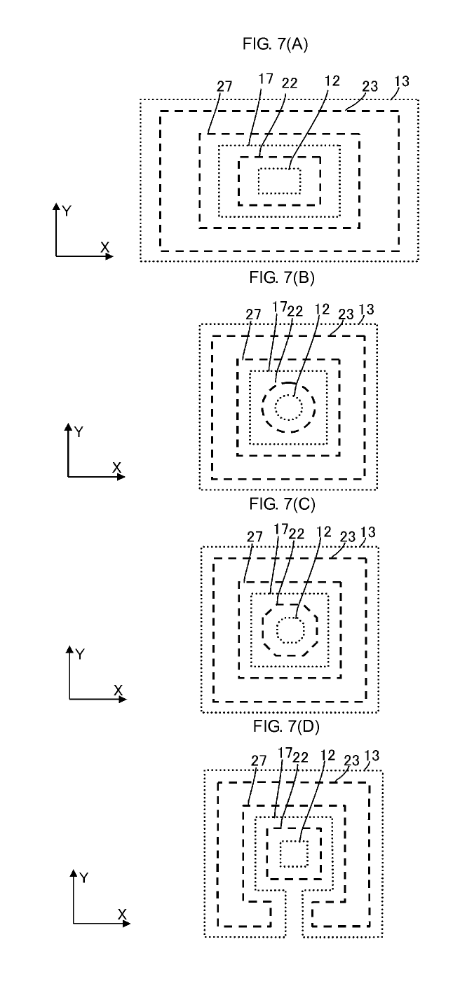

FIGS. 7(A)-(D) show plan views illustrating modifications of the shapes of the power transmission electrode pattern and the power reception electrode pattern.

In the power transmission electrode pattern and the power reception electrode pattern illustrated in FIG. 7(A), the outer shapes of the power-transmission-side active electrode and the power-reception-side active electrode and the outer shapes and opening shapes of the power-transmission-side passive electrode and the power-reception-side passive electrode are all rectangular.

In this case as well, a constant power transmission efficiency can be maintained from the standard arrangement to the maximally shifted arrangement even if the relative positional relationship between the power transmission device and the power reception device is shifted along any axis due to the dimensional relationships between the electrodes and the openings as described above being maintained along the axes.

In addition, so long as the dimensional relationships between the electrodes and the openings is maintained as described above along at least one axis, the present invention can be suitably implemented.

In the power transmission electrode pattern and the power reception electrode pattern illustrated in FIG. 7(B), the outer shapes of the power-transmission-side active electrode and the power-reception-side active electrode are circular and the outer shapes and opening shapes of the power-transmission-side passive electrode and the power-reception-side passive electrode are all square.

In this case as well, a constant power transmission efficiency can be maintained from the standard arrangement to the maximally shifted arrangement even if the relative positional relationship between the power transmission device and the power reception device is shifted along an axis due to the dimensional relationships between the electrodes and the openings described above being maintained along the X axis and the Y axis.

In addition, the outer shapes of the power-transmission-side active electrode and the power-reception-side active electrode and the outer shapes and opening shapes of the power-transmission-side passive electrode and the power-reception-side passive electrode may be combined in any way.

In the power transmission electrode pattern and the power reception electrode pattern illustrated in FIG. 7(C), the outer shapes of the power-transmission-side active electrode and the power-reception-side active electrode have polygonal shapes with a greater number of sides than a rectangle and the outer shapes and opening shapes of the power-transmission-side passive electrode and the power-reception-side passive electrode are all square.

In this case as well, a constant power transmission efficiency can be maintained from the standard arrangement to the maximally shifted arrangement even if the relative positional relationship between the power transmission device and the power reception device is shifted along an axis due to the dimensional relationships between the electrodes and the openings described above being maintained along the X axis and the Y axis.

Both the active electrodes and the passive electrodes may have a polygonal shape and the number of sides may be any number.

In the power transmission electrode pattern and the power reception electrode pattern illustrated in FIG. 7(D), the outer shapes of the power-transmission-side active electrode and the power-reception-side active electrode are rectangular and the power-transmission-side passive electrode and the power-reception-side passive electrode have the shape of a Landolt ring having a notch provided in part thereof.

In this case as well, a constant power transmission efficiency can be maintained from the standard arrangement to the maximally shifted arrangement even if the relative positional relationship between the power transmission device and the power reception device is shifted along an axis due to the dimensional relationships between the electrodes and the openings described above being maintained along the X axis and the Y axis.

The shapes of the active electrodes and the passive electrodes are not limited to being circular shapes or polygonal shapes and may be any kind of shape. For example, each electrode may be divided into a plurality of separate regions or they may have elliptical shapes. In addition, so long as there is no change in their superposed surface areas the active electrodes may have openings thereinside. In addition, in the above-described examples, examples have been described in which the active electrodes and the passive electrodes are provided so as to be on the same flat surfaces in the power transmission device and power reception device, but not limited to this and the active electrodes and the passive electrodes may be provided at different positions in a direction orthogonal to the planes of the electrodes as far as a coupling capacitance is generated between a power-transmission-side electrode and a power-reception-side electrode.

### REFERENCE SIGNS LIST

10 . . . power transmission device
11 . . . alternating-current power generation circuit
12, 32, 52 . . . power-transmission-side active electrode
13, 33, 53 . . . power-transmission-side passive electrode
20 . . . power reception device
21 . . . load circuit
22, 42, 62 . . . power-reception-side active electrode
23, 43, 63 . . . power-reception-side passive electrode
17, 27, 37, 47, 57, 67 . . . opening
14 . . . oscillation circuit
15 . . . amplification circuit
16 . . . booster circuit
24 . . . voltage lowering circuit
25 . . . rectification circuit
26 . . . power supply circuit

1. A wireless power transmission system comprising:
a power transmission device including:
a first power transmission electrode disposed in a plane parallel to a transmission/reception plane defined by the wireless power transmission system,
a second power transmission electrode parallel to the first power transmission electrode and having an internal opening that surrounds the first power transmission electrode and being concentric with the first power transmission electrode, and
an alternating-current power generation circuit coupled to the first and second power transmission electrodes; and
a power reception device including:
a first power reception electrode disposed in a position parallel to the transmission/reception plane when the power reception device is positioned on the power transmission device,
a second power reception electrode parallel to the first power reception electrode and having an internal opening that surrounds the first power reception electrode and being concentric with the first power reception electrode, and
a load circuit coupled to the first and second power reception electrodes,
wherein one of the first power transmission electrode and the first power reception electrode completely overlaps the other of the first power transmission electrode and the first power reception electrode when the power reception device is positioned on the power transmission device in a standard arrangement in which respective centers of the first power transmission electrode and the first power reception electrode are superposed with each other in a direction perpendicular to the transmission/reception plane, and
wherein at least one of the power transmission device and the power reception device can be shifted from the standard arrangement by a predetermined shift distance along a first axis in the transmission/reception opposition plane while maintaining that the one of the first power transmission electrode and the first power reception electrode completely overlaps the other of the first power transmission electrode and the first power reception electrode.

2. The wireless power transmission system according to claim 1, wherein in the standard arrangement, an edge of the first power transmission electrode and the first power reception electrode positioned outside of the respective electrodes and a boundary line of the internal opening of the respective one of the second power transmission electrode and the second power reception electrode are separated from each other along the first axis by at least the predetermined shift distance.

3. The wireless power transmission system according to claim 1, wherein the second power transmission electrode and the second power reception electrode are disposed in the standard arrangement such that one of the second power transmission electrode and the second power reception electrode surrounds the other.

4. The wireless power transmission system according to claim 1, wherein one of the power transmission device and the power reception device can be shifted from the standard arrangement along the first axis where the respective centers of the first power transmission electrode and the first power reception electrode serve as a reference position while maintaining that one of the first power transmission electrode and the first power reception electrode completely overlaps the other.

5. The wireless power transmission system according to claim 4, wherein a11 denotes a dimension of one of the first power transmission electrode and the first power reception electrode along the first axis, a12 denotes a dimension of the other of the first power transmission electrode and the first power reception electrode along the first axis, and g11 denotes a dimensional difference between the respective dimensions, with a12−a11=g11>0.

6. The wireless power transmission system according to claim 5, wherein a13 denotes a dimension of the internal opening of one of the second power transmission electrode and the second power reception electrode along the first axis and a14 denotes a dimension of the internal opening of the other of the second power transmission electrode and the second power reception electrode along the first axis, with a13≦g11+a12 and a14≧a13.

7. The wireless power transmission system according to claim 6, wherein a14≧g11+a13.

8. The wireless power transmission system according to claim 5, wherein a11 denotes a dimension of the first power transmission electrode along the first axis, a13 denotes a dimension of the internal opening of the second power transmission electrode along the first axis, and a13=g11+a12.

9. The wireless power transmission system according to claim 5, wherein a11 denotes a dimension of the first power reception electrode along the first axis, a13 denotes a dimension of the internal opening of the second power reception electrode along the first axis, and a13=g11+a12.

10. The wireless power transmission system according to claim 1, wherein one of the power transmission device and the power reception device can be shifted with respect to the other from the standard arrangement along a second axis that is orthogonal to the first axis at the reference position while maintaining that the one of the first power transmission electrode and the first power reception electrode completely overlaps the other.

11. The wireless power transmission system according to claim 10, wherein a21 denotes a dimension of one of the first power transmission electrode and the first power reception electrode along the second axis, a22 denotes a dimension of the other of the first power transmission electrode and the first power reception electrode along the second axis, and g21 denotes a dimensional difference between the respective dimensions, a22−a21=g21>0.

12. The wireless power transmission system according to claim 11, wherein a23 denotes a dimension of the internal opening of one of the second power transmission electrode and the second power reception electrode along the second axis and a24 denotes a dimension of the internal opening of the other of the second power transmission electrode and the second power reception electrode along the second axis, with a23≦g21+a22 and a24≧a23.

13. The wireless power transmission system according to claim 12, wherein a11=a21, a12=a22, a13=a23 and a14=a24.

14. The wireless power transmission system according to claim 1, wherein each of the first power transmission electrode, the first power reception electrode, and the respective internal openings of the second power transmission electrode and the second power reception electrode comprises rectangular shapes.

15. The wireless power transmission system according to claim 1, wherein each of the first power transmission electrode, the first power reception electrode, and the respective internal openings of the second power transmission electrode and the second power reception electrode comprise circular shapes.

16. A wireless power transmission device for transmitting power to a power reception device having a first power reception electrode and a second power reception electrode parallel to the first power reception electrode and having an internal opening that surrounds the first power reception electrode and being concentric with the first power reception electrode, the wireless power transmission device comprising:
a first power transmission electrode disposed in a plane parallel to a transmission/reception plane between the power transmission device and the power reception device when the power reception device is positioned on the power transmission device;
a second power transmission electrode parallel to the first power transmission electrode and having an internal opening that surrounds the first power transmission electrode and being concentric with the first power transmission electrode; and
an alternating-current power generation circuit coupled to the first and second power transmission electrodes,
wherein one of the first power transmission electrode and the first power reception electrode completely overlaps the other of the first power transmission electrode and the first power reception electrode when the power reception device is positioned on the power transmission device in a standard arrangement in which respective centers of the first power transmission electrode and the first power reception electrode are superposed with each other in a direction perpendicular to the transmission/reception plane, and
wherein the power reception device can be shifted relative to the power transmission device from the standard arrangement by a predetermined shift distance along a first axis in the transmission/reception opposition plane while maintaining that the one of the first power transmission electrode and the first power reception electrode completely overlaps the other of the first power transmission electrode and the first power reception electrode. (Corresponds to claim 1, but focused on transmission device)

17. The wireless power transmission device according to claim 16, wherein in the standard arrangement, an edge of the first power transmission electrode and the first power reception electrode positioned outside of the respective electrodes and a boundary line of the internal opening of the respective one of the second power transmission electrode and the second power reception electrode are separated from each other along the first axis by at least the predetermined shift distance.

18. The wireless power transmission device according to claim 16, wherein the power reception device can be shifted relative to the power transmission device from the standard arrangement along the first axis where the respective centers of the first power transmission electrode and the first power reception electrode serve as a reference position while maintaining that one of the first power transmission electrode and the first power reception electrode completely overlaps the other.

19. The wireless power transmission device according to claim 18, wherein a11 denotes a dimension of one of the first power transmission electrode and the first power reception electrode along the first axis, a12 denotes a dimension of the other of the first power transmission electrode and the first power reception electrode along the first axis, and g11 denotes a dimensional difference between the respective dimensions, with a12−a11=g11>0.

20. The wireless power transmission device according to claim 19, wherein a13 denotes a dimension of the internal opening of one of the second power transmission electrode and the second power reception electrode along the first axis and a14 denotes a dimension of the internal opening of the other of the second power transmission electrode and the second power reception electrode along the first axis, with a13≦g11+a12 and a14≧a13.
